(19) United States
(12) Patent Application Publication
(10) Pub. No.: US 2018/0267637 A1
(43) Pub. Date: Sep. 20, 2018

(54) FINGER-OPERATED CONTROL BAR, AND USE OF THE FINGER-OPERATED CONTROL BAR

(71) Applicant: VOLKSWAGEN AG, Wolfsburg (DE)

(72) Inventors: Holger WILD, Berlin (DE); Nils KÖTTER, Braunschweig (DE)

(21) Appl. No.: 15/539,126

(22) PCT Filed: Dec. 17, 2015
(86) PCT No.: PCT/EP2015/080203

§ 371 Date: Jun. 22, 2017

(30) Foreign Application Priority Data
Dec. 22, 2014 (DE) 10 2014 226 760.9
Jan. 2, 2015 (DE) 10 2015 200 011.7

(51) Int. Cl. G06F 3/0354; G06F 3/0484; G06F 3/0488

(52) U.S. Cl. CPC G06F 3/03547; B60K 37/06; G06F 3/04883; G06F 3/04847

(57) ABSTRACT

An infotainment system, a device for operating an infotainment system of a locomotion device, a locomotion device, a user interface as well as a method for the output of feedback about an input with the aid of a finger-operated control bar are provided. The method includes the steps of detecting a predefined number of fingers placed on the finger-operated control bar, and in response thereto, emitting a light color that is allocated to the number of placed fingers, with the aid of a light outlet.

In a first aspect (“finger-operated control bar”), the present invention relates to an infotainment system, a means of locomotion, and a device for operating an infotainment system of a means of locomotion; and in a second aspect (“use of the finger-operated control bar”), it relates to a user interface and a method for outputting feedback about a user input made with the aid of a finger-operated control bar.

### DESCRIPTION OF THE INVENTION

### “Finger-Operated Control Bar”

Infotainment System, Means of Locomotion, and Device for Operating an Infotainment System of a Means of Locomotion

### BACKGROUND INFORMATION

The present invention relates to a means of locomotion, an infotainment system, and a device for operating an infotainment system of a means of locomotion. In particular, the present invention relates to a possibility for inputting infinitely variable input values with the aid of swiping gestures without the user having to gaze at the user interface in order to make selective inputs.

The trend in cockpits of current means of locomotion, especially motor vehicles, at present is headed in the direction of switchless designs. This also means that conventional rotary/push button control elements are to be omitted, and thus no essential haptic feedback in response to user inputs takes place. As a result, there is a need for a user interface and an input element that integrates well into the optics of a switchless cockpit yet still provides satisfactory orientation as well as optical feedback to the customer when important functions are adjusted (e.g., audio volume, scrolling through long lists, the operation of a climate-control system, etc.).

The document DE 10 2012 008681 A1 describes a multi-function operating device for a motor vehicle, in which a combined slider/touch panel is provided for accepting swiping gestures and inputs via pressure. The operating element has a longitudinal or rectangular design, and a raised edge projection is provided to guide the finger of the user. Preferably, the operating element is situated along the side of the screen display, essentially vertically.

DE 10 2013 000 110 A1 describes an operating method and an operating system in a vehicle, in which, in repose to the touching of a touch-sensitive surface on a second display area, command buttons displayed in a first display area are modified in such a way that supplementary information associated with the command button is displayed in the first display area. A touch-sensitive surface for a capacitive interaction with an operating object (such as a capacitive touch screen) is provided for this purpose.

DE 10 2008 048 825 A1 describes a display and operating system in a motor vehicle having a user-adaptive display; here, a modifier mode can be activated via a user input, in which a graphic display of all display objects at least partially takes place in a sub-region of the display area. This makes it possible to display objects that were previously distributed across an entire display area in such a sub-region that is located within a reaching distance of a user.

Starting from the previously cited related art, it is an object of the present invention to integrate a comfortable input device for swiping gestures into the interior of a means of locomotion in an optically advantageous manner. It is a further object of the present invention to develop feedback to a user of such a system in such a way that it is intuitively comprehensible.

### DISCLOSURE OF THE INVENTION

In the present invention, the objective identified above is achieved by a device for operating an infotainment system of a means of locomotion. The device includes a finger-operated control bar that extends in linear or curved fashion and is configured for the haptic (longitudinal) guidance of a finger of a user. In other words, a one-dimensional track is predefined for the finger of the user. Such a track especially has a concave and/or convex (sub-)structure transversely to its longitudinal direction, which is able to be haptically detected by a user within the course of a swiping gesture and be used for orienting the finger on the finger-operated control bar. In addition, a detection unit is provided for detecting swiping gestures executed on the finger-operated control bar. The detection unit is able to detect (for instance, in a capacitive manner) a movement of human tissue executed on the finger-operated control bar and convert it into electrical signals. An evaluation unit is provided for processing detected swiping gestures (or signals generated thereby) and may be implemented in the form of a programmable processor, a microcontroller, a nano-controller or a similar device. In addition, the device has a linear light outlet, which at least roughly extends completely along the finger-operated control bar. The light outlet may be a partially transparent plastic and/glass glass element, and/or a sinter body through which an illumination means disposed behind it is able to emit light in the direction of the user. In response to a user gesture detected with the aid of the detection unit, the device according to the present invention is able to acknowledge the user gesture by a light signal emitted from the light outlet. For example, a started function is able to be acknowledged by a light pattern allocated to the function. The light pattern may also have one or more colors, which are unequivocally allocated to the respective started function. Also independently of a successful start of a function allocated to the gesture, the operation of the device is able to be acknowledged by an output of a corresponding light signal. In particular in the case of a swiping gesture, a shimmer (also a glow or corona) may be generated around the finger(s), which moves along with the finger and thereby informs the user in which way the device has detected his or her gesture. Even just an approach or a placement of one or more finger(s) may already be interpreted as a user gesture, and a chaser light or a plurality of chaser lights is/are generated along the light outlet (e.g., starting at its edge or edges) in the direction of the finger(s), so that even unpracticed users receive an intuitively comprehensible signal that lets them know that they have just found or used an input interface.

Clauses 2 through 15 show preferred further refinements of the present invention.

The finger-operated control bar may be provided for a horizontal placement, for instance. This has the advantage that a ledge or rest for a finger is developed in the vertical direction. As a result, accelerations created in the vertical direction (e.g., when passing over a bump or a pothole) will not shift the finger of the user out of an intended space region in front of the finger-operated control bar. The operation of the device becomes particularly intuitive when the finger-operated control bar is situated above and/or below a display area in a means of locomotion. The device or the finger-operated control bar provided according to the present invention then has a strong relationship with the display areas and will intuitively be seen as a component of a user interface. A particularly pleasant and self-explanatory surface feel results if the finger-operated control bar is developed in the form of a trough-shaped or depression-shaped longitudinal groove, which follows a surface of a (planar or curved) screen, for example.

The light outlet is preferably inserted into the finger-operated control bar, so that the emitted light signal is associated with the user gesture to a particularly pronounced degree. In other words, in an operation of the finger-operated control bar according to the present invention, the light outlet is passed over as well, so that the acknowledging light signal appears to be situated in the immediate vicinity and, in particular, also under the respective finger of the user.

A suitable possibility for realizing the acknowledging light signals consists of placing a light source behind the light outlet, which includes individual illumination means (e.g., light-emitting diodes, LEDs) that have an especially rapid response speed with regard to electrical signals that actuate them. This allows for a particularly precise output of light signals acknowledging the user gesture. In particular, a translucent (generally also known as “milky”) element for homogenizing light emitted by the light outlet may be provided. The translucent element thereby provides for a diffusion of the irradiated light in the direction of the user, as a result of which the inhomogeneous light source appears optically more attractive on the one hand, yet still allows for a precise positioning of the light signal on the other hand.

The variety of possible inputs becomes particularly obvious to the user when the finger-operated control bar is delimited on both sides by optically and/or haptically delimited end regions for the development of key fields. For example, bars which the user is able to feel clearly may be provided transversely to the longitudinal extension of the finger-operated control bar. As an alternative or in addition, grooves that extend transversely to the longitudinal direction of the finger-operated control bar may be provided for optically and haptically delimiting a swiping region between the end regions from the key fields. In this way an operation of the key fields can basically also take place without the user visually detecting the device. This enhances the traffic safety during the operation of the device according to the present invention. For example, repeated push inputs with regard to one of the key fields may be used in order to change a function allocated to the swiping region (“toggling”). Possible functions that are able to be “switched through” with the aid of the key fields will be elucidated in the further course of the present description. For example, using a long-press gesture, a function selected for the swiping region may be allocated to the swiping region also for future operating steps. In this way a permanent allocation of a user-desired function to the swiping area is able to take place.

In the region of the key fields, the light outlet may preferably be set up to output a predefined other light color in all other areas of the finger-operated control bar, regardless of a current light color. The same holds true for a light intensity. In other words, the regions of the light outlet in the end regions are preferably delimited from the swiping-gesture region of the finger-operated control bar in an optically non-transparent manner. For example, three translucent components of the light outlet in the region of the optical and/or haptic delimitation may be interrupted by two opaque (i.e. optically “non-transparent”) structures. For instance, these optical interruptions may project from a surface of the finger-operated control bar in such a way that they provide a haptic delimitation of the end regions. Preferably, optical crosstalk of light is at least avoided in that the opaque structures are not superposed by translucent elements in the direction of the user. However, an especially homogeneous surface may be obtained if a completely transparent element makes up the surface of the finger-operated control bar.

The detection unit may have a linear system of a multitude of capacitive antennas that are situated next to each other in the main extension direction (longitudinal direction) of the finger-operated control bar in a region behind the finger-operated control bar. In other words, the individual capacitive antennas follow the linear form of the finger-operated control bar, so that especially many different input positions on the finger-operated control bar are able to be resolved by the detection unit and reported to the evaluation unit. In comparison with capacitive surfaces of touch-sensitive screens, the individual capacitive antennas have the advantage of a more flexible configurability in regard to sensitivity and range. For example, the detection unit is able to detect not only touches but also approaches of a user without contact with the finger-operated control bar and report these to the evaluation unit.

For instance, the device according to the present invention may include a display unit having a touch-sensitive surface and a haptic barrier on the display unit extending in the form of a line or curve. The barrier is used for delimiting a display area of the display unit from an edge region of the display unit that is provided for the development of a finger-operated control bar according to the present invention. A segment of the touch-sensitive surface of the display unit situated in the region of the finger-operated control bar thus serves as a detection unit for detecting pressure/push and swiping gestures of a user. Accordingly, a segment of the display unit that is situated in the region of the finger-operated control bar may form the light outlet of the device. In other words, the light outlet is developed in the form of a linear segment of a self-luminous display unit. Due to the haptic barrier, the display unit is able to provide the display area on the one hand, and the detection unit and the light outlet of the device according to the present invention on the other, despite the fact that the display unit is able to be produced as an integrally formed element. This increases the stability of the device, reduces the number of components, dispenses with assembly operations and lowers the production costs. In the automotive production, components produced in one piece moreover avoid problems of creaking, rattling and the undesired ingress of dirt, and thereby prevent malfunctions.

Preferably, a proximity sensor system may be provided in addition, and the evaluation unit is designed to use a light signal emitted from the light outlet to acknowledge a gesture detected with the aid of the proximity sensor system. In other words, it is not the case that only a touching interaction of the user with the finger-operated control bar is acknowledged according to the present invention; instead, a light signal is already output in response to an approach of the user of the finger-operated control bar so as to inform the user that the device according to the present invention allows for an input using touch and what such an interaction might look like. For example, this may be realized by light variations and/or blinking patterns whereby the user is animated to input swiping or multi-touch gestures.

The evaluation unit is preferably set up for evaluating a first predefined gesture on the finger-operated control bar for the purpose of adjusting a volume of a media playback. For example, the first gesture may be a swiping gesture using a single finger. As an alternative or in addition, the evaluation unit is designed to evaluate a second predefined gesture on the finger-operated control bar for the purpose of adjusting a volume of a voice output of the infotainment system. The second gesture, for example, may be a swiping gesture using exactly two fingers (multi-touch gesture). Alternatively or additionally, the evaluation device may be designed to evaluate a third predefined gesture on the finger-operated control bar in order to adjust a volume of sound signs or acoustic warning tones. For example, the third gesture may be a multi-touch swiping gesture carried out using exactly three fingers. An allocation between the aforementioned gestures and exemplary functional ranges may be modified as desired without departing from the scope of the present invention.

Depending on which type of gesture or which type of function begun by the gesture is at hand, a respective informational text and/or a respective information symbol may be output on a display unit of the device.

As an alternative or in addition, a light signal output via the light outlet may acknowledge the function and the type of detected gesture independently of each other. For example, the gesture type may be illustrated or acknowledged by a position or multiple positions of greater light intensity. The operated functions are able to be illustrated through the use of different colors. For example, in an operation of a climate control function with the aid of a swiping gesture, the light signal may be varied in the direction of blue or in the direction of red as a function of a reduction or an increase in a setpoint temperature. If the function involves a volume modification, then a change from a white light in the direction of a red light may be made when the volume is to be increased, or the other way around, from a red light color to white light when the volume is reduced. Of course, light of a first color may virtually completely act on the light outlet in order to illustrate the manner of the function adjustment, while a second color is selected for light emitted in the region of the user's finger, by which the detected gesture is acknowledged (e.g., independently of an adjusted function).

In addition, the evaluation unit may be developed to adapt a light signal emitted from the light outlet to a current setting of the ambience light of the means of locomotion in response to an elapsing of a predefined time period following an end of a gesture detected with the aid of the detection unit. In other words, the light outlet as well as the illumination means situated behind it may be used to assist in an ambience light concept, provided the finger-operated control bar according to the present invention is not currently being used for receiving user gestures or for acknowledging them. The predefined time period after which an automatic switch to the ambience light mode takes place following a user interaction, may be a minimum time period in the form of a whole-number multiple of a second in the range between one second and ten seconds, for instance. In this way, the device according to the present invention will be used in an even more varied manner for the optically pleasing development of the passenger compartment that is operable in an intuitive as well as comfortable manner.

According to a second aspect of the present invention, an infotainment system for a means of locomotion is provided, which includes a device according to the initially mentioned invention aspect. In other words, in a further development, the device according to the present invention is supplemented by functional ranges such as music playback and/or a navigation function. Accordingly, it is also possible to adapt and illustrate heating/climate-control scopes via the device according to the present invention. The features, feature combinations and the advantages resulting therefrom correspond to those of the initially mentioned aspect of the present invention, so that reference is made to the above comments in order to avoid repetitions.

According to a third aspect of the present invention, a means of locomotion is provided, which has an infotainment system according to the invention aspect mentioned second, or a device according to the invention aspect mentioned first. The means of locomotion may be a passenger car, a delivery van, a truck, a motorcycle, an aircraft and/or a watercraft, for example. With regard to features, feature combinations and the advantages of the means of locomotion resulting therefrom, reference is made once again to the above comments in order to avoid repetitions.

### BRIEF DESCRIPTION OF THE DRAWING

Hereinafter, exemplary embodiments of the present invention are described in detail with reference to the attached drawing. The figures show:

FIG. 1 a schematic overview of components of an exemplary embodiment of a means of locomotion according to the present invention, with an exemplary embodiment of a device according to the present invention;

FIG. 2 a perspective drawing of an exemplary embodiment of a device according to the present invention;

FIG. 3 a detail view of a cutaway of the exemplary embodiment shown in FIG. 2;

FIG. 4 a plan view of an exemplary embodiment of a detection unit used according to the present invention, including a multitude of capacitive antennas; and

FIG. 5 a schematic diagram which illustrates an exemplary embodiment of a device according to the present invention, in which a display unit having a touch-sensitive surface provides a display area, a detection unit, and a light outlet of a device according to the present invention.

### SPECIFIC EMBODIMENTS OF THE INVENTION

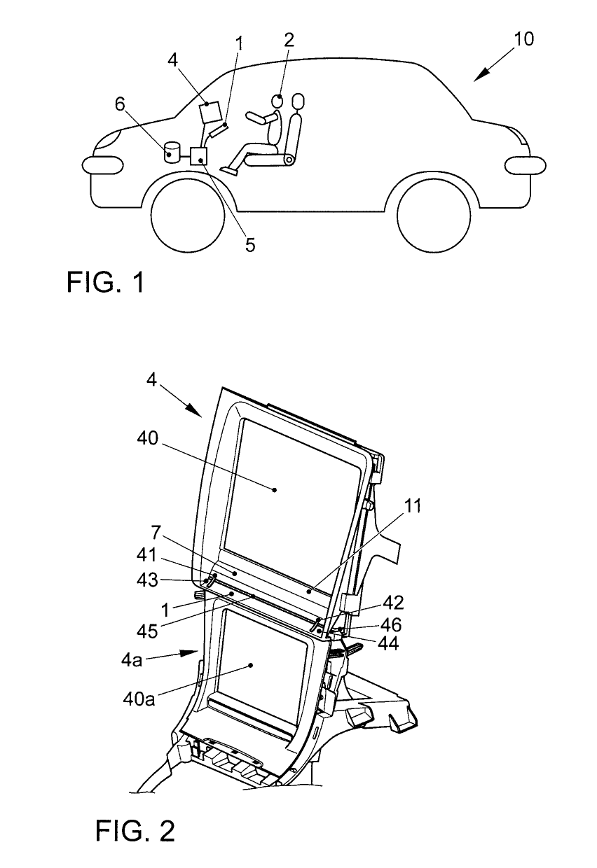

FIG. 1 shows a passenger car 10 as a means of locomotion, in which a screen 4 as a display unit is connected in an IT-based manner to an electronic control unit 5 as the evaluation unit. A finger-operated control bar 1 disposed horizontally underneath screen 4 is connected in an IT-based manner to electronic control unit 5 for the detection of user gestures and for the optical acknowledgement of such user gestures with the aid of light signals. A data memory 6 stores predefined references for the classification of user gestures and is utilized for defining light-signal patterns allocated to the classified user gestures. A user 2 extends his or her arm essentially horizontally in order to execute a swiping gesture on finger-operated control bar 1. Without a configuration of finger-operated control bar 1 according to the present invention, vertical accelerations of passenger car 10 would cause the user to sometimes miss finger-operated control bar 1. In addition, user 2 would have to focus his eyes on finger-operated control bar 1 in order to accurately position his finger on finger-operated control bar 1. According to the present invention, these processes may be omitted because finger-operated control bar 1 has an advantageous ledge-type structure for guiding the finger of user 2.

FIG. 2 shows an exemplary embodiment of a device according to the present invention, which has two screens 4, 4a that are essentially provided on top of each other for a placement in a center console or in an instrument panel of a means of locomotion. From the top down, display areas 40, 40a of screens 4, 4a are sequentially set apart from one another by a bar-shaped frame part 11 as a haptic barrier, an infrared LED bar 7 as a proximity sensor system, and a concavely developed finger-operated control bar 1, into which a line-shaped light outlet 45 which follows the longitudinal extension of finger-operated control bar 1 has been inserted. Distal regions 43, 44 of finger-operated control bar 1 are identified as buttons and delimited from a central swiping-gesture region of finger-operated control bar 1 by bar structures 41, 42 that are oriented perpendicular to the longitudinal extension direction. Abutting the line-shaped light outlet 45 is a light guide 46, which essentially extends in the driving direction and guides light coming from the driving direction in the direction of the user in order to generate acknowledging light signals.

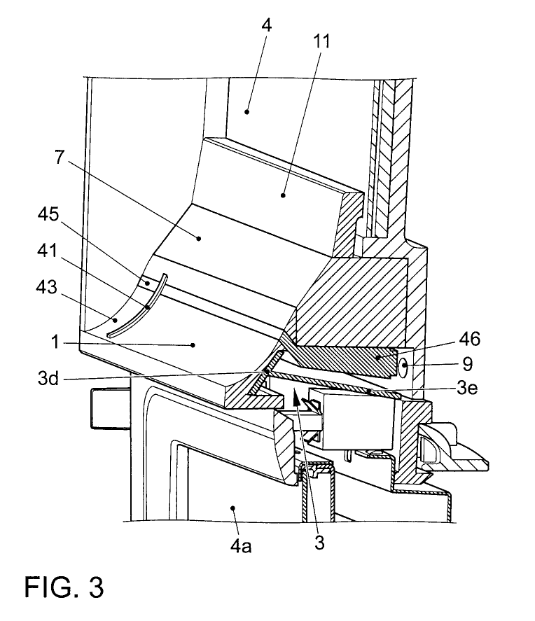

FIG. 3 shows a detail view of the exemplary embodiment of a device according to the present invention shown in FIG. 2. In this view, an LED 9 as an illumination means of a light source is provided in the driving direction on light guide 46 by way of example, through which a narrow yet diffuse or blurrily delimited region of light exit 45 is lit up by light from LED 9. A carrier 3d of a capacitive detection unit 3, which is mechanically and electrically connected to a circuit board 3e, is situated just underneath the surface of finger-operated control bar 1. Circuit board 3e carries electronic components (not shown) for the operation of detection unit 3.

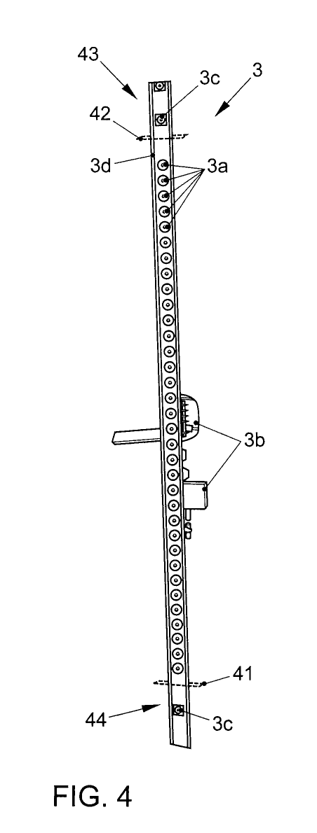

FIG. 4 shows an exemplary embodiment of a detection unit 3 as it has been introduced in FIG. 3. In the plan view of FIG. 4, capacitive antennas 3a, situated next to one another in the form of a line, can be seen on carrier 3d; they are developed in the shape of a circular disk in each case and are situated equidistantly from one another. Bars 41, 42, shown by dashed lines, mark end regions 43, 44, which have a respective square-shaped capacitive antenna 3c for accepting pressure and/or push and/or long-press gestures. In FIG. 3, electronic components 3b are assembled on the circuit board (reference numeral 3e) and provided for the operation of antennas 3a, 3c.

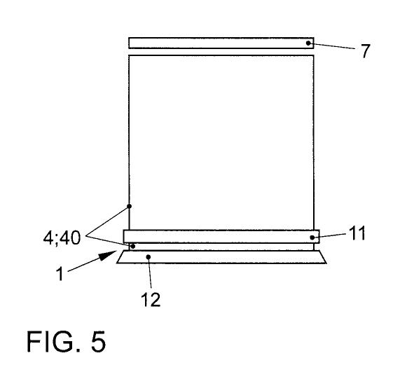

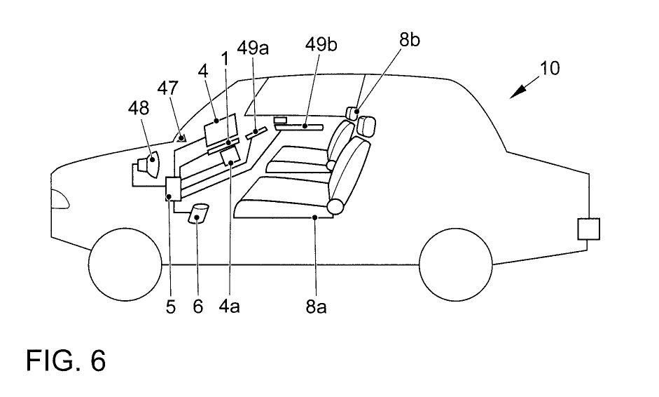

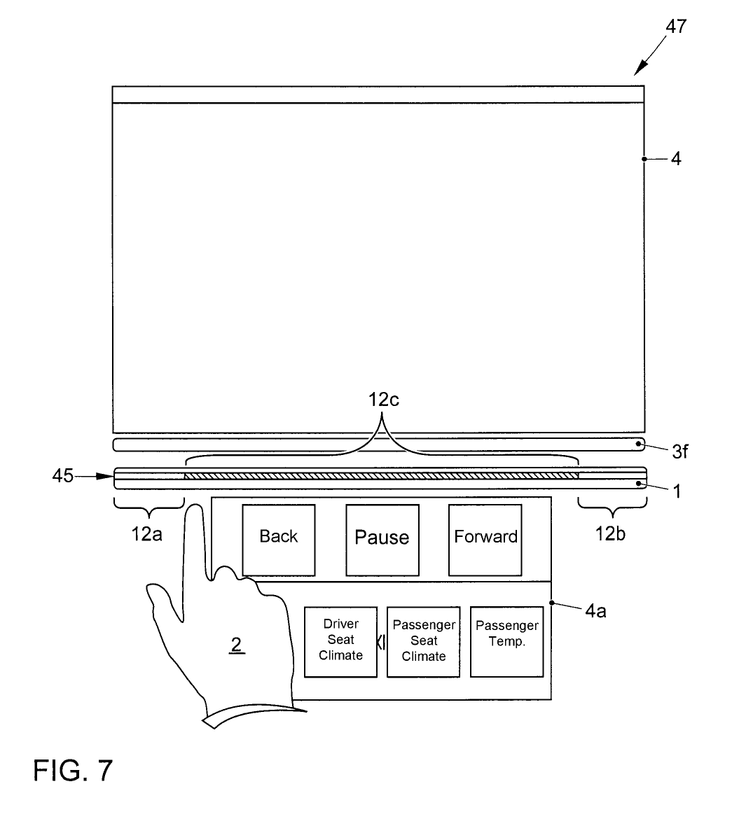

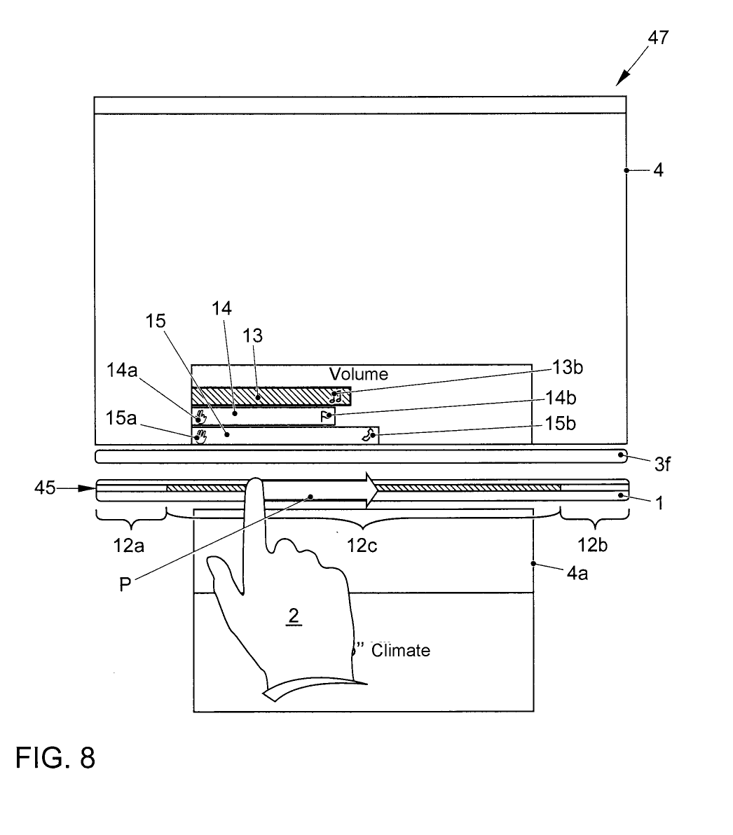

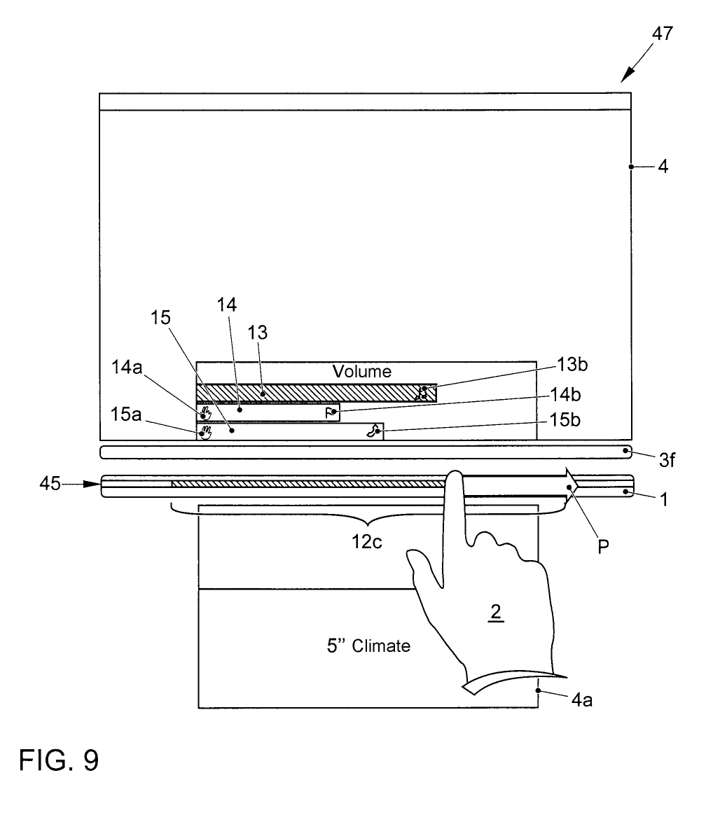

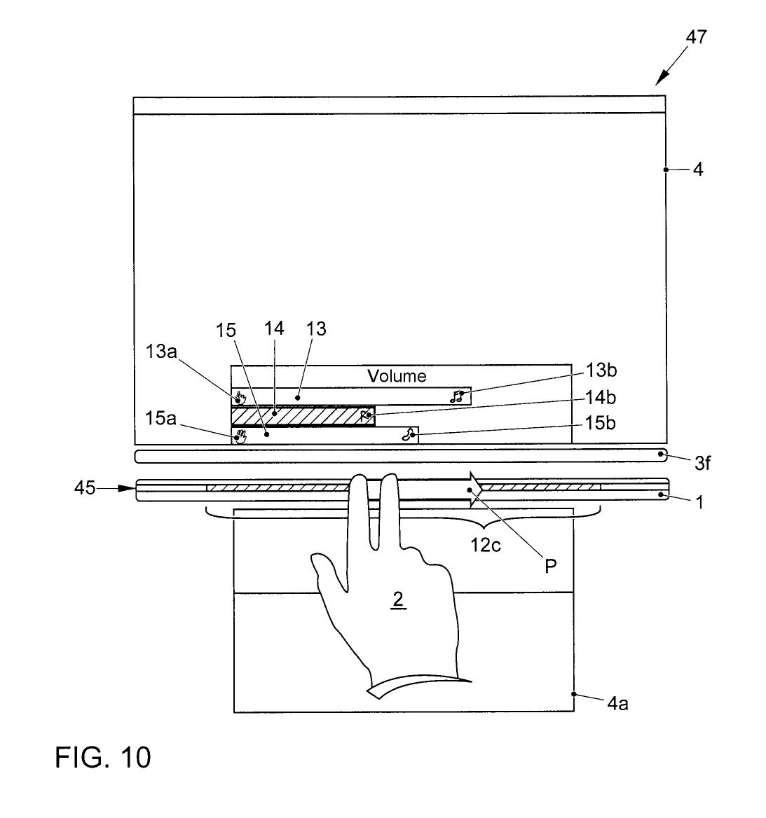

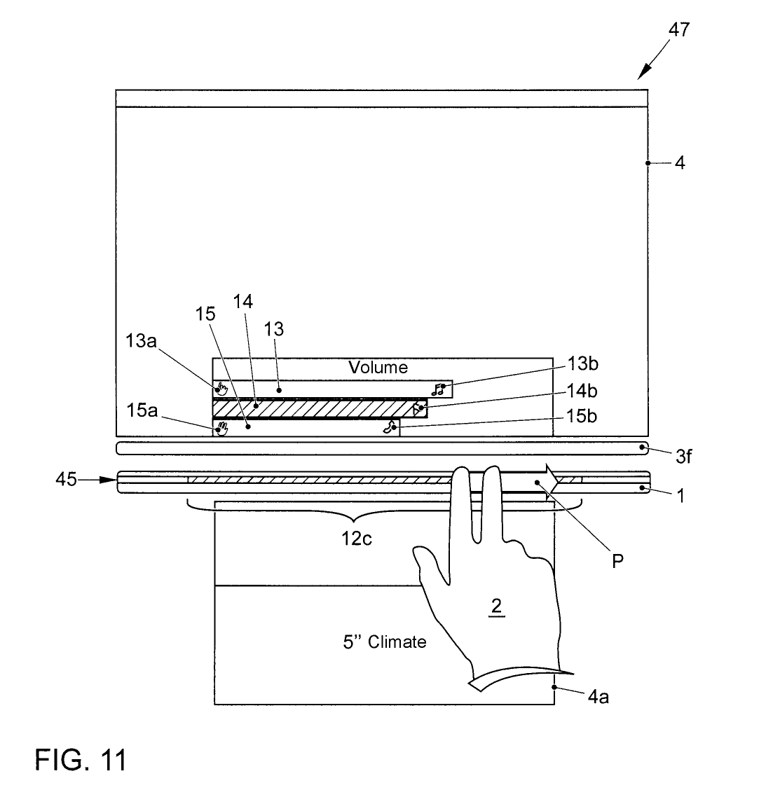

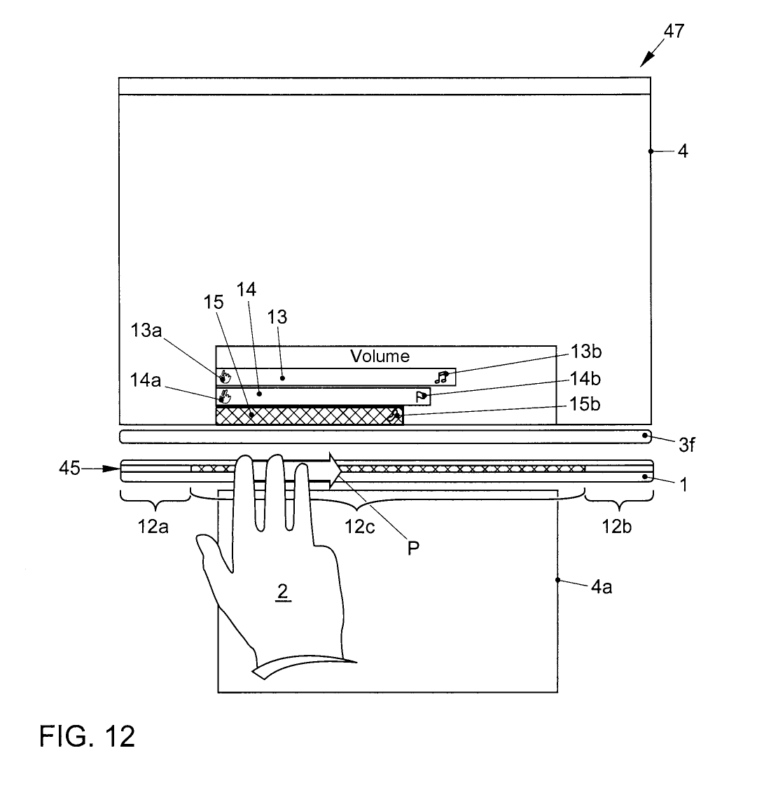

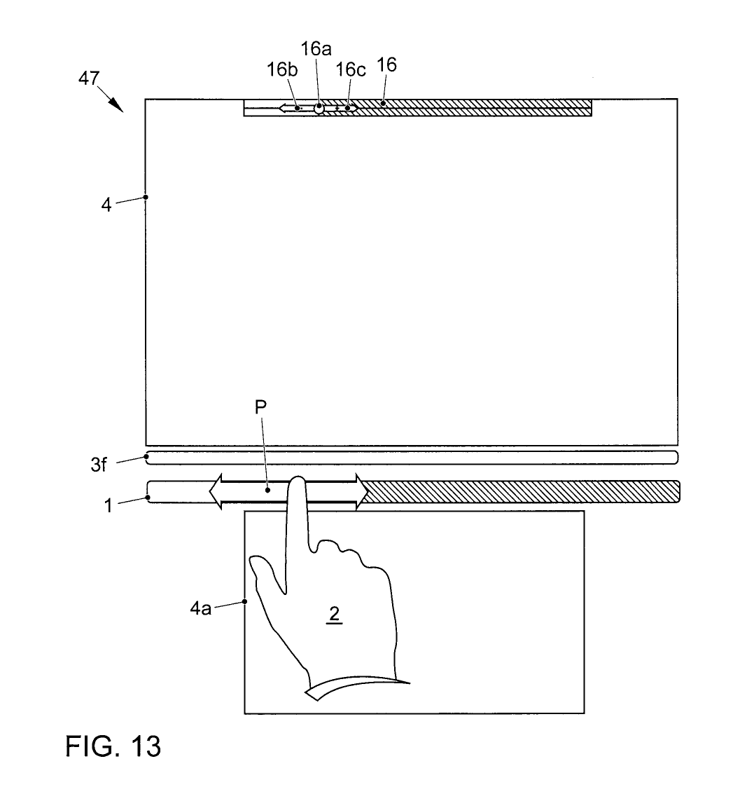

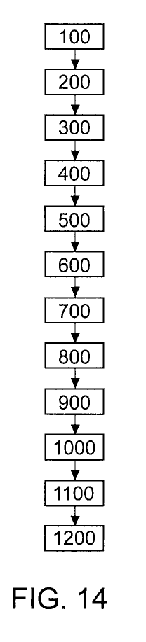

FIG. 5 shows a schematic diagram of an alternative exemplary embodiment of a device according to the present invention for operating an infotainment system. Situated above a screen 4 including a display area 40 is a proximity sensor system 7 for detecting a hand of a user approaching the device. An essentially horizontally extending bar 11 on screen 4 delimits a narrow surface region of display area 40 that is allocated to a finger-operated control bar 1 according to the present invention, from a main display region of display area 40. Screen 4 is developed in the form of a touch screen (the English term for “touch-sensitive display unit”), as it is known from the related art. However, in order to realize a device according to the present invention, a display area 40 situated above bar 11 is controlled in a completely different manner than a region disposed underneath bar 11 that forms the detection unit and the light outlet of the device. In other words, an integrally formed screen 4 in the form of a touch screen is provided, whose lower edge forms the detection unit and the light outlet of the device according to the present invention. In the downward direction, finger-operated control bar 1 is delimited by an essentially horizontal ledge 12 for placing a finger and for its guidance while executing a swiping gesture.

Notwithstanding that the aspects according to the present invention and the advantageous specific embodiments have been described in detail on the basis of the exemplary embodiments elucidated in connection with the attached figures of the drawing, one skilled in the art will be able to modify and combine features of the illustrated exemplary embodiments without departing from the scope of the present invention, which is further defined in the attached clauses. Hereinafter, individual subject matters of the present invention are listed in the form of clauses for the sake of better clarity:

Clauses
1. A device for operating an infotainment system of a means of locomotion (10), comprising:
   a linearly or curvilinearly extending finger-operated control bar (1) for the haptic guidance of a finger of a user (2),
   a detection unit (3) for detecting swiping gestures performed on the finger-operated control bar (1),
   an evaluation unit (5) for processing detected swiping gestures, and
   a linear light outlet (45), which at least approximately extends completely along the finger-operated control bar (1), the device being designed to acknowledge a user gesture, detected with the aid of the detection unit (3), with the aid of a light signal emitted from the light outlet (45).
2. The device as recited in Clause 1, wherein the finger-operated control bar (1)
   is designed for a horizontal placement in the means of locomotion (10), in particular above and/or below a display area (40, 40a), and/or
   has a trough-shaped surface for guiding the finger, and/or
   has a ledge (12) for placing a finger.
3. The device as recited in Clause 1 or 2, wherein the light outlet (45) is inserted into the finger-operated control bar (1).
4. The device as recited in one of the preceding clauses, wherein a light source (9) is situated behind the light outlet (45), which
   includes individual illumination means, preferably LEDs, and in particular
   a translucent element is provided to homogenize light emitted from the light outlet (45).
5. The device as recited in one of the preceding clauses, wherein the finger-operated control bar (1) is restricted on both sides by optically and/or haptically delimited end regions (43, 44) for the development of key fields.
6. The device as recited in Clause 5, wherein the light outlet (45) is designed to emit a predefined other light color in the region of the key fields, independently of a light color in all other regions of the finger-operated control bar.
7. The device as recited in one of the preceding clauses, wherein
   the detection unit (3) has a linear system of a multitude of capacitive antennas (3a), which are disposed next to one another behind the finger-operated control bar (1) in the main extension direction of the finger-operated control bar (1).
8. The device as recited in one of the preceding Clauses 1 through 5, furthermore including
   a display unit (4) having a touch-sensitive surface and
   a linearly or curvilinearly extending haptic barrier (11) on the display unit (4) for delimiting a display area (40) from the finger-operated control bar (1), wherein
   a segment of the touch sensitive surface situated in the region of the finger-operated control bar (1) forms the detection unit (3) of the device, and
   a segment of the display unit (4) situated in the region of the finger-operated control bar (1) forms the light outlet (45) of the device.
9. The device as recited in one of the preceding clauses, furthermore comprising a proximity sensor system (7), the evaluation unit (5) being designed to acknowledge a gesture detected with the aid of the proximity sensor system (7) by a light signal emitted from the light outlet (45).
10. The device as recited in one of the preceding clauses, wherein the evaluation unit (5) is designed
   to evaluate a first gesture on the finger-operated control bar (1) for adjusting a volume of a media playback and/or
   to evaluate a second gesture on the finger-operated control bar (1) for adjusting a volume of a voice output of the infotainment system, and/or
   to evaluate a third gesture on the finger-operated control bar (1) for adjusting a volume of sound signs.
11. The device as recited in Clause 10, wherein the evaluation unit (5) is designed to acknowledge an evaluated first gesture and/or second gesture and/or third gesture of a user by an optical output of a first or second or third informational text and/or by a reference symbol on a display unit (4).
12. The device as recited in one of the preceding clauses, wherein the finger-operated control bar is designed to resolve multi-touch gestures, and the evaluation device (5) is designed
   to acknowledge a gesture performed by exactly one finger by a first light signal,
   to acknowledge a multi-touch gesture performed by exactly two fingers by a second light signal, and in particular,
   to acknowledge a multi-touch gesture performed by exactly three fingers by a third light signal, which are emitted from the light outlet in each case, a position of the output of the light signal in particular matching the respective gesture or multi-touch gesture.
13. The device as recited in one of the preceding clauses, wherein the evaluation unit (5) is furthermore designed to adjust a light signal emitted from the light outlet (45) to a current setting of the ambience light of the means of locomotion (10) in response to an elapsing of a predefined time period following the end of a gesture detected with the aid of the detection unit (3).
14. An infotainment system including a device as recited in one of the preceding clauses.
15. A means of locomotion including an infotainment system as recited in Clause 14 or a device as recited in one of the preceding Clauses 1 through 13.

### Description of the Invention

### “Use of the Finger-Operated Control Bar”

“User Interface and Method for the Output of Feedback About a User Input Made Using a Finger-Operated Control Bar”

### Background Information

The present invention relates to a user interface and to a method for the output of feedback about an input by a user made using a finger-operated control bar. In particular, the present invention relates to a simple and intuitive possibility for the input of swiping gestures that pertain to different volume adjustments.

Modern means of locomotion increasingly dispense with switches developed in hardware that are allocated to only a single function. Instead, the increasing functional ranges are displayed and operated via screens (also: touch screens). In an effort to save additional hardware elements, a so-called “finger-operated control bar” has been proposed in the preceding text, which allows for a one-dimensional guidance of the finger of a user during a swiping gesture. Applicant has described such a finger-operated control bar in the application filed at the German Patent and Mark Office on Dec. 22, 2014, which bears the number DE 10 2014226760.9 and is entitled “Infotainmentsystem, Fortbewegungsmittel and Vorrichtung zur Bedienung eines Infotainmentsystems eines Fortbewegungsmittels” [Infotainment System, Means of Locomotion, and Device for Operating an Infotainment System of a Means of Locomotion], whose priority the present application is claiming and whose content is hereby incorporated by reference.

U.S. Pat. No. 8,026,902 B2 describes an input device for a means of locomotion, by which slide controllers can be displayed and used for adjusting audio volumes and climate-control settings.

JP 2010-36620 describes a user terminal on whose display a slide controller can be displayed and used for adjusting an audio volume.

The approaches known from the related art do not provide satisfactory solutions for adjusting different audio volumes.

In particular, the potential of a finger-operated control bar for guiding a swiping gesture while piloting a means of locomotion is not being recognized. As a result, it is an object of the present invention to remedy the disadvantages of the related art identified in the preceding text.

### Disclosure of the Invention

According to the present invention, the objective identified above is achieved by a method for the output of feedback about an input made with the aid of an input device for accepting two-dimensionally controlled, one-dimensional swiping gestures (hereinafter: “finger-operated control bar”). The method includes the step of detecting a predefined number of fingers placed on the finger-operated control bar. In other words, the finger-operated control bar is able to resolve the number of fingers touching it and to generate corresponding control signals. In response to the detected numbers of placed fingers, a light color that corresponds to this number is emitted. For example, this may be accomplished with the aid of an illumination means that the user can see while operating the finger-operated control bar. The illumination means in particular may be provided in the vicinity of the finger-operated control bar or as a component of the finger-operated control bar. Especially if different functions are adapted with the aid of swiping gestures performed on the finger-operated control bar as a function of the number of fingers placed, the emitted light color provides the user with important information as to the effect of his swiping gesture.

The dependent claims show preferred further refinements of the present invention.

According to the present invention, a brightness of the emitted light color is already able to be adjusted as a function of a currently adjusted volume while the user is approaching the finger-operated control bar. The user thereby receives optical feedback about the loudness at which an audio output would currently occur. In particular in the event that no audio signal is currently being output, the brightness is therefore able to provide important information as to the extent and the direction in which an adjustment has to take place in order to realize a current user preference.

In order to further assist the user, a brightness variation is able to be displayed along the finger-operated control bar in response to a detected touching of the finger-operated control bar by an input means (such as a hand of a user), thereby giving the user an indication as to how a direction of swiping gestures affects the audio volume. More specifically, areas of low brightness may represent low audio volumes and areas of greater brightness may represent higher volumes.

Preferably, the placing of another finger is able to be detected during the execution of a swiping gesture on the finger-operated control bar, and the implemented light color may be modified in response in order to inform the user that the audio signal source adjusted by the user's swiping gesture has now been switched over as well. In other words, the number of fingers placed may represent a particular audio signal source (e.g., media playback, telephony, navigation/voice outputs, etc.). By increasing the number of fingers placed on the finger-operated control bar, a particularly rapid switchover of the adjusted audio signal source is able to take place.

In the event that the number of fingers placed on the finger-operated control bar is reduced in the course of the swiping gesture, the previously emitted light color may remain unchanged. As an alternative or in addition, the allocation of the swiping gesture to the audio signal source whose volume is adjusted may also remain unchanged. In other words, for example, a multi-touch swiping gesture for adjusting the volume of a navigation output may be started and continued in the form of a one-finger swiping gesture so as to enhance the user comfort, without losing the allocation to the navigation-output volume. In particular, swiping gestures started using two or three fingers may thus be continued or completed as one-finger swiping gestures without thereby adjusting an audio signal source, originally allocated to the one-finger swiping gesture, with regard to its volume.

For the switch-off of the user interface developed according to the present invention, a user input having a predefined minimum length (“long-press gesture”) using the finger-operated control bar may preferably be detected, the length in particular amounting at least to two seconds and preferably at least to three seconds. In response, the user interface will be switched off. The switch-off of the user interface may also pertain merely to a display device of the user interface, so that, for example, a background illumination (backlight) of the display unit is switched off, thereby reducing both the light bar emitted into the passenger compartment for one, and the withdrawn electrical power of the user interface for another.

According to a second aspect of the present invention, a user interface for a means of locomotion is provided. The user interface includes an input device to accept controlled one-dimensional swiping gestures (“finger-operated control bar”), which may also encompass a proximity sensor system. An “approach” within the scope of the present invention may be understood as a detection of a predefined proximity of the input means prior to establishing contact with the user interface. In addition, the user interface includes a light outlet and an evaluation unit. The light outlet, for example, may be coupled with an illumination means (in particular LED-based) and set up to emit light of the illumination means into the passenger compartment via a light guide. The evaluation unit may also be understood as an electronic control device which includes a programmable processor (e.g., microcontroller, nano-controller, or a similar device). The finger-operated control bar is designed to resolve a number of placed fingers and to convert that number into corresponding electrical signals, which are received by the evaluation unit. The evaluation unit is in turn configured to select a light color that is predefined for the number of placed fingers and to instruct the light outlet to emit the selected light color. In other words, the user interface according to the present invention is designed to execute or support a method according to the initially mentioned invention aspect, so that the features, feature combinations and the advantages of the initially mentioned invention aspect that result therefrom correspondingly result for the user interface; to avoid repetitions, reference is made to the method according to the present invention.

For example, the light outlet may be linearly disposed along the finger-operated control bar. In particular, the light outlet may be integrated into the finger-operated control bar in such a way that the finger of a user also passes over the light outlet when performing a swiping gesture on the finger-operated control bar. In the process, a current position of the finger on the finger-operated control bar may be marked by a particular color and/or a particular intensity in order to supply feedback to the user as to the position at which his finger is currently detected by the user interface.

According to the present invention, the evaluation device may be designed to detect an additional finger placed on the finger-operated control bar and to vary the emitted light color in response. In other words, the evaluation unit recognizes from the signals of the finger-operated control bar that a further finger has been placed on the finger-operated control bar, in addition to the at least one currently placed finger, and acknowledges the detected number of fingers by a corresponding actuation of the illumination means. As an alternative or in addition, the evaluation unit is designed to detect a reduced number of fingers placed on the finger-operated control bar and to keep a previously emitted light color in response. In other words, in particular no adjustment of the emitted light color takes place in response to a reduced number of placed fingers. Accordingly, there will also be no adjustment of a function allocated to the swiping gesture (e.g., an audio volume, a climate-control adjustment, etc.) given a reduced number of placed fingers. This allows for a particularly ergonomic adjustment of such functions that are allocated to multi-touch swiping gestures.

In response to a swiping gesture that was started with a first number of fingers placed on the finger-operated control bar, the user interface may be designed to adjust an audio volume for a media playback (e.g., music playback or the playback of video material). As an alternative or in addition, in response to a swiping gesture that was started with a second number of fingers placed on the finger-operated control bar, the user interface is able to adjust an audio volume for a navigation announcement. As an alternative or in addition, the user interface may adapt an audio volume for a telephony function in response to a swiping gesture started by a third number of fingers placed on the finger-operated control bar. The above statements apply in particular under the condition that the number of fingers placed is not increased during the swiping gesture, the reason being that this may optionally be provided for another allocation of the effect of the swiping gesture to a functional range. The first plurality, for example, may be a single finger that is placed on the finger-operated control bar. The second plurality, for instance, may include exactly two fingers. As an alternative, the second plurality may include exactly three fingers. Alternatively or additionally, the third plurality may include exactly two fingers. The third plurality may just as well include exactly three fingers. The adjustment of audio volumes is developed particularly ergonomically in that, particularly under the condition that currently only a single audio signal source is outputting an audio signal, a swiping gesture using only one finger always adapts the audio volume of the currently outputting audio signal source, regardless of which audio signal source is allocated to a one-finger swiping gesture in other operating states. In other words, during an output of a navigation announcement, for example, a one-finger swiping gesture is able to adjust the volume of the navigation output, while in other operating states of the user interface a multi-touch swiping gesture on the finger-operated control bar is provided for adjusting the navigation volume, for example. The same applies to the telephony volume, which may be adjusted using only one finger during a telephone conversation or during an incoming call, for instance, although a multi-touch swiping gesture is provided for adjusting the telephony volume in other operating states of the user interface.

The user interface may preferably include a display unit that is set up to display a slide controller on the display device in response to a detection of a swiping gesture on the finger-operated control bar. The slide controller describes the currently adjusted audio volume as well as the allocated audio signal source and, optionally, a number of fingers that is predefined for the adjustment while using the finger-operated control bar. The slide controller, for example, may superimposed to a status bar (usually an uppermost line in a graphic user interface). Optionally, also a plurality or even all audio volumes of the audio signal sources operable using the finger-operated control bar may be displayed accordingly (e.g., on top of one another). The slide controllers may have different colors in order to inform the user of the color in which the finger-operated control bar glows if the particular audio signal source is currently being adjusted. As an alternative or in addition, the slide controllers may have pictograms symbolizing the number of fingers to be placed (initially) in order to adjust the audio signal source with the aid of the finger-operated control bar. The slide controller(s) may also be developed to receive user inputs directly. For this purpose, the display device may have a touch-sensitive surface that can resolve swiping gestures and/or push gestures on the slide controller(s).

According to a third aspect of the present invention, a computer program product (such as a data memory) is provided on which instructions are stored that enable an evaluation unit of a user interface according to the present invention to execute the steps of a method according to the initially mentioned invention aspect. The computer program product may be developed as a CD, DVD, Blue-Ray disk, a flash memory, hard disk, RAM/ROM, cache, etc.

According to a fourth aspect of the present invention, a signal sequence is provided that represents instructions which enable an evaluation unit of a user interface according to the present invention to execute the steps of a method according to the initially mentioned invention aspect. In this way, the IT-based provision of the instructions is also protected in the event that the storage means required for this purpose lie outside the scope of the appended claims.

### Brief Description of the Drawing

Hereinafter, exemplary embodiments of the present invention are described with reference to the appended drawing. The figures show:

FIG. 6 a schematic overview of components of an exemplary embodiment of a means of locomotion according to the present invention with an exemplary embodiment of a user interface according to the present invention;

FIG. 7 the result of an approach of a hand of a user toward an exemplary embodiment of a user interface according to the present invention;

FIG. 8 a representation of a swiping gesture by the hand of a user on a finger-operated control bar of an exemplary embodiment of a user interface according to the present invention;

FIG. 9 a representation of the result of a single-finger swiping gesture on the finger-operated control bar of an exemplary embodiment of a user interface according to the present invention;

FIG. 10 a representation of an execution of a two-finger swiping gesture by the hand of a user on a finger-operated control bar of an exemplary embodiment of a user interface according to the present invention;

FIG. 11 a representation of the result of a two-finger swiping gesture on the finger-operated control bar of an exemplary embodiment of a user interface according to the present invention;

FIG. 12 a representation of an execution of a three-finger swiping gesture on the finger-operated control bar of an exemplary embodiment of a user interface according to the present invention;

FIG. 13 a representation of a superimpositioning of a slide controller on a display device of an exemplary embodiment of a user interface according to the present invention, in response to the execution of a swiping gesture on a finger-operated control bar; and

FIG. 14 a flow diagram illustrating steps of an exemplary embodiment of a method according to the present invention for the output of feedback about an input with the aid of a finger-operated control bar.

### Specific Embodiments of the Present Invention

FIG. 6 shows a passenger car 10 as an exemplary embodiment of a means of locomotion having a user interface 47. Two screens 4, 4a in the form of touch screens are inserted as display device in the instrument panel of passenger car 10. A finger-operated control bar 1 as part of a detection unit is disposed between screens 4, 4a. A data memory 6 is provided for storing instructions that configure user interface 47 for the execution of a method according to the present invention. A loudspeaker 48 is provided for the output of informational tones and signal tones as well as for the acoustic background music of user inputs and responses of user interface 47. The aforementioned components, as well as two ambience light bars 49a and 49b that are inserted in the instrument panel or a door of passenger car 10, are connected in terms of IT technology to an electronic control device 5 as the evaluation unit. A driver seat 8a and a passenger seat 8b are provided to accommodate a driver and a passenger as potential users of user interface 47 according to the present invention.

FIG. 7 shows an approach of a hand of a user 2 toward a user interface 47 according to the present invention. A finger-operated control bar 1 and an infrared LED bar 3f are provided between screen 4 and screen 4a as part of an input device for detecting an approach of the hand. Finger-operated control bar 1 has distal buttons 12a, 12b between which a swiping-gesture region 12c is situated. Entire finger-operated control bar 1 is interspersed by a linear light outlet 45, which outputs a brightness variation in response to the detected approach in swiping-gesture region 12c. The brightness variation indicates to the user in which direction a swiping gesture is to be performed in order to increase or reduce the audio volume currently allocated to finger-operated control bar 1.

FIG. 8 shows the execution of a single-finger swiping gesture on finger-operated control bar 1 along an arrow P, the gesture being predefined for adjusting an audio volume of a current audio volume (here, “media playback”). Three slide controllers 13, 14, 15 are shown on screen 4, slide controller 13 having a pictogram 13b (“note symbol”) and a bar color that matches the light color emitted by light outlet 45 in swiping-gesture region 12c. Shown below slide controller 13 is a slide controller 14, which shows a pictogram 14a (“hand with two extended fingers”) and a pictogram 14b (“target flag”). The color of slide controller 14 is currently black. Depicted underneath slide controller 14 is a slide controller 15 for adjusting a telephone volume, which has a pictogram 15a (“hand with three extended fingers”) and a pictogram 15b (“telephone receiver”). The bar color of sliding ruler 15 is currently black.

FIG. 9 shows the result of a continued swiping gesture of the hand of user 2 in the direction of arrow P, in response to which the bar of slide controller 13 has been extended in the direction of arrow P and pictogram 13b has been shifted correspondingly to the right. The audio volume of the media playback is increased to a corresponding degree.

FIG. 10 shows an execution of a two-finger swiping gesture of a hand of a user 2 on finger-operated control bar 1 in the direction of an arrow P, in response to which slide controller 14 has a blue bar color that corresponds to the light emitted by light outlet 45 in swiping-gesture region 12c. To show the user in which way he may switch for the adjustment of the volume of the media playback, upper slide controller 13 now has a pictogram 13a (“hand with an extended finger”). Slide controller 13 is now shown in black (“inactive”).

FIG. 11 shows the result of a continued two-finger gesture by the user on finger-operated control bar 1, in response to which the bar of slide controller 14 extends accordingly in the direction of arrow P, and pictogram 14b has been shifted accordingly to the right.

FIG. 12 shows the execution of a three-finger swiping gesture by the hand of a user 2 on finger-operated control bar 1, in response to which light outlet 45 outputs green light in swiping-gesture region 12c corresponding to the bar color of slide controller 15. Slide controller 14 on screen 4 is now shown in black and carries a pictogram 14a in order to illustrate to the user that a two-finger swiping gesture is to be executed on finger-operated control bar 1 in order to adjust the navigation output volume. The continuation of the depicted three-finger swiping gesture on finger-operated control bar 1 in the direction of arrow P increases the volume of the telephony output, extends the bar of shift controller 15 in the direction of arrow P, and shifts pictogram 15b to the right accordingly.

FIG. 13 shows the execution of a one-finger swiping gesture on an alternative exemplary embodiment of a user interface 47 according to the present invention. A double arrow P illustrates a swiping gesture that may be executed on finger-operated control bar 1 in the horizontal direction. In response, a slide controller 16, which has a color variation that corresponds to the light emitted from the light outlet is superimposed to a status bar (not shown) at the upper edge of screen 4. A current position 16a of slide controller 16 represents the audio volume currently adjusted with the aid of the hand of user 2. An arrow 16b, bearing a minus symbol and pointing toward the left, illustrates the reduction in the current audio volume as the effect of a swiping gesture directed toward the left, and animates the user to adjust the audio volume with the aid of a slide controller 16. An arrow 16c, provided with a plus symbol and directed toward the right, illustrates the swiping gesture in the direction of an increase in the volume of a currently output audio source.

FIG. 14 illustrates steps of a method for the output of feedback about an input with the aid of the finger-operated control bar. In step 100, an approach of a user toward a detection unit is detected, whereupon a brightness of an emitted light color is adapted in step 200 as a function of a currently set volume. In step 300, touching of the finger-operated control bar by a hand of a user is detected and in response, a brightness variation is shown in step 400, where regions of low brightness represent lower volumes and regions of high brightness represent louder volumes.

In step 500, a predefined number of fingers placed on the finger-operated control bar is detected and a light color that is allocated to the number of placed fingers is emitted in step 600 in response. The light color also represents an audio signal source allocated to the finger-operated control bar, or it represents the effect of a swiping gesture on the finger-operated control bar on the audio signal source. In step 700, the placement of additional fingers on the finger-operated control bar is detected and in response thereto, the emitted light color as well as the function allocated to the swiping gesture are modified in step 800. In step 900, a reduced number of fingers placed on the finger-operated control bar during a swiping gesture is now detected and no variation of the emitted light color takes place in step 1000 in response. Accordingly, an audio signal source that was allocated to the finger-operated control bar prior to the lifting of the finger(s) also remains allocated to the swiping gesture on the finger-operated control bar. In step 1100, a user input having a predefined minimum duration (“long-press”) is detected that lasts two seconds. In response, the user interface is switched off in a step 1200. As a minimum, the backlight of a display device of the user interface is switched off in the process.

Notwithstanding that the aspects according to the present invention and the advantageous specific embodiments have been described in detail on the basis of the exemplary embodiments elucidated in connection with the figures in the attached drawing, one skilled in the art will be able to modify and combine features of the illustrated exemplary embodiments without departing from the scope of the present invention, whose scope is defined by the appended claims.

### LIST OF REFERENCE NUMERALS

1 finger-operated control bar
2 user
3 detection unit
3a capacitive antennas
3b electronic components
3c capacitive antennas (touch region)
3d carrier
3e circuit board of the detection unit
3f infrared LED bar
4, 4a screen
5 electronic control device
6 data memory
7 proximity sensor system
8a driver seat
8b passenger seat
9 LED
10 passenger car
11 bar/frame part
12 ledge
12a, 12b buttons on the finger-operated control bar
12c swiping-gesture region on the finger-operated control bar
13, 14, 15 slide controller
13a, 14a, 15a pictogram
13b, 14b, 15b pictogram
16 slide controller
16a current position of the slide controller
16b, 16c horizontal arrows in the direction of lower or higher volumes
40, 40a display area
41, 42 haptic limits
43, 44 end regions
45 light outlet
46 light guide
47 user interface
48 loudspeaker
49a, 49b ambience light bars
100 through 1200 method steps
P arrow

1-16. (canceled)

17. A method for outputting feedback about an input with the aid of an input device for accepting controlled one-dimensional swiping gestures arranged as a finger-operated control bar, comprising:
detecting a predefined number of fingers placed on a finger-operated control bar; and
in response to the detecting, emitting a light color that is allocated to the number of placed fingers.

18. The method according to claim 17, further comprising:
detecting an approach of a user; and
in response to the detection of the approach of the user, adjusting a brightness of the emitted light color as a function of a currently set audio volume.

19. The method according to claim 17, further comprising:
detecting touching of the finger-operated control bar by an input device; and
in response to the detection of the touching, displaying a brightness variation, in which regions of low brightness represent regions for definition of lower volumes, and regions of greater brightness represent regions for definition of higher volumes.

20. The method according to claim 17, further comprising:
detecting another finger placed on the finger-operated control bar; and
in response to the detection of another finder, varying the emitted light color.

21. The method according to claim 17, further comprising:
detecting a reduced number of fingers placed on the finger-operated control bar during a swiping gesture; and
in response to the detection of the reduced number of fingers, maintaining a previously emitted light color.

22. The method according to claim 17, furthermore comprising:
detecting a user input having a predefined minimum duration, a duration of at least two second, and/or a duration of at least three seconds; and
in response to the detection of the user input having the predefined minimum duration, the duration of at least two second, and/or the duration of at least three seconds, switching off the user interface.

23. A user interface for a locomotion device, comprising:
an input device adapted to accept controlled one-dimensional swiping gestures, the input device arranged as a finger-operated control bar;
a light outlet; and
an evaluation unit;
wherein the finger-operated control bar is adapted to resolve a number of placed fingers, and the evaluation unit is adapted to select a light color that is preselected for the number of fingers placed, and the light outlet is adapted to emit the selected light color.

24. The user interface according to claim 23, wherein the user interface has a linear configuration and is situated parallel to a longitudinal extension of the finger-operated control bar.

25. The user interface according to claim 23, wherein the light outlet is integrated into the finger-operated control bar.

26. The user interface according to claim 23, wherein the evaluation unit is adapted to:
detect another finger placed on the finger-operated control bar and vary the emitted light color in response to the detection of another finger; and/or
detect a reduced number of fingers placed on the finger-operated control bar and maintain a previously emitted light color in response to the detection of a reduced number of fingers.

27. The user interface according to claim 23, wherein the user interface is adapted to:
adjust an audio volume for a media playback in response to a swiping gesture started using a first number of fingers placed on the finger-operated control bar;
adjust an audio volume for a navigation announcement in response to a swiping gesture started using a second number of fingers placed on the finger-operated control bar; and/or
adjust an audio volume for a telephony volume in response to a swiping gesture started using a third number of fingers placed on the finger-operated control, if the number of placed fingers is not increased during the wiping gesture.

28. The user interface according to claim 27, wherein the first plurality includes a single finger, the second plurality includes exactly two fingers, and/or the third plurality includes exactly three fingers.

29. The user interface according to claim 23, wherein the user interface is adapted to:
adjust a volume of a navigation output in response to a swiping gesture performed using only one finger while a navigation output is taking place; and/or
adjust a volume of a telephone call in response to a swiping gesture executed using only one finger during the telephone call.

30. The user interface according to claim 23, further comprising a display device adapted to superimpose a slide controller to a status bar displayed on the display device in response to a swiping gesture on the finger-operated control bar, the slide controller adapted to always be set to a currently adjusted volume to receive touching user inputs for the adjustment of a volume.

31. A non-transitory, computer-readable medium comprising computer-executable instructions for performing the method recited in claim 17.

32. A locomotion device, comprising:
a user interface as recited in claim 23.
